(19) United States
(12) Patent Application Publication
(10) Pub. No.: US 2007/0262597 A1
(43) Pub. Date: Nov. 15, 2007

(54) Reaching apparatus with telescoping handles

(76) Inventor: Nicholas Ramos, Huntington Beach, CA (US)

Correspondence Address: AVERILL & VARN, 8244 PAINTER AVE., WHITTIER, CA, 90602, US

(21) Appl. No.: 11/432,085

(22) Filed: May 11, 2006

(51) Int. Cl. B25J 1/02

(52) U.S. Cl. 294/19.1

(57) ABSTRACT

A compact reaching device includes jaws and telescoping handles. The jaws are joined by a hinge pin and are biased towards a closed position. Legs extend opposite the jaws and squeezing the legs together opens the jaws. Telescoping handles are attached to each leg and may be extended opposite the jaws to allow reaching.

### BACKGROUND OF THE INVENTION

The present invention relates to reaching devices and in particular to reaching devices with telescoping handles.

Individuals often have a need to retrieve nearby items, but are unable to easily or safely reach for the items. In some instances, the individual is driving an automobile and needs to pick up an item which has fallen, for example, on the passenger-side floor of the car. Such items include ipod® personal audio devices, sunglasses, compact disks, and especially cell phones. Often, a driver leaves their cell phone unsecured in the car. While rounding a turn, the cell phone may side from it's resting place and onto the car's floor often landing on the passenger side floor and beyond the driver's reach.

Because drivers often have an unexpected need for their cell phone, they may attempt to retrieve the fallen phone. Attempting to reach for the phone while still driving may result in an accident. The driver may pull to the side of the road and reach for the phone, but may not be able to reach the phone while still wearing a seatbelt, and thus have to release the seat belt. In some instances, the driver may still be unable to reach the phone after releasing the seat belt, or may be unable to reach the phone without straining their back. In these instances the driver may have to exit the car and walk to the passenger door to be able to reach the phone, which may involve some risk on a busy highway.

There are many other instances where objects are beyond easy reach. Examples include an individual with a back injury or an elderly individual, when an item falls behind large objects.

Reaching devices are known for retrieving items beyond easy reach. One example is the “Gopher Pick Up & Reach Tool” made by Ontel Products in Fairfield, N.J., and the “40ez EZ Reach” made by AM Leonard in Piqua, Ohio. While both of these products provide a reaching capability, they are too long to easily carry in an automobile or in a pocket.

A reaching device with telescoping handles is disclosed in U.S. Pat. No. 5,152,569 for “Litter Picking Tool.” The device of the '569 patent includes telescoping handles attached to a jaw mechanism. The handles are connected at an end opposite the jaws and the jaws include a toothed mechanism for opening the jaws then the handles are squeezed together. Unfortunately, the toothed mechanism adds significant complexity to the reaching tool thus adding to cost and reducing reliability.

### BRIEF SUMMARY OF THE INVENTION

The present invention addresses the above and other needs by providing a compact reaching device which includes jaws and telescoping handles. The jaws are joined by a hinge pin and are biased towards a closed position. Legs extend opposite the jaws and squeezing the legs together opens the jaws. Telescoping handles are attached to each leg and may be extended opposite the jaws to allow reaching.

In accordance with one aspect of the invention, there is provided a reaching device including an alligator clip or the like and telescoping handles attached to the alligator clip. The alligator clip includes first and second members, pivot pin, and a spring. The members have jaws, legs opposite the jaws, and pivots between the jaws and the legs, and the leg have receiving loops. The pivot pin passes through the pivots to pivotally join the members and the spring cooperates with the members to bias the jaws towards a close position. The arms have telescoping sections, and the smallest telescoping sections of each of the telescoping sections passes through the receiving loop of each leg, reaching near to the pivot pin, and are attached to the legs of each alligator clip, and the arms are extendable approximately opposite the jaws. The attached sections are preferably brazed to the legs, and preferably retain their original shape, for example, are not deformed by crimping.

### BRIEF DESCRIPTION OF THE SEVERAL VIEWS OF THE DRAWING

The above and other aspects, features and advantages of the present invention will be more apparent from the following more particular description thereof, presented in conjunction with the following drawings wherein:

FIG. 1A is a side view of a reaching device according to the present invention with telescoping handle fully extended and jaws in a closed position.

FIG. 1B is a side view of the reaching device telescoping handle fully extended and with the jaws in an open position.

FIG. 1C is a side view of the reaching device telescoping handle partially extended and with the jaws in an open position.

FIG. 1D is a side view of the reaching device telescoping handle closed and with the jaws in an open position.

FIG. 2 is a detailed partial side view of the reaching device with cover removed from one leg and jaw.

FIG. 3A is a side view of one leg and one jaw of the reaching device.

FIG. 3B is a top view of one leg and one jaw of the reaching device.

FIG. 3C is a bottom view of one leg and one jaw of the reaching device.

FIG. 3D is a front view of one leg and one jaw of the reaching device.

FIG. 4 is a cross-sectional view of the reaching device taken along line 44 of FIG. 3D.

Corresponding reference characters indicate corresponding components throughout the several views of the drawings.

### DETAILED DESCRIPTION OF THE INVENTION

The following description is of the best mode presently contemplated for carrying out the invention. This description is not to be taken in a limiting sense, but is made merely for the purpose of describing one or more preferred embodiments of the invention. The scope of the invention should be determined with reference to the claims.

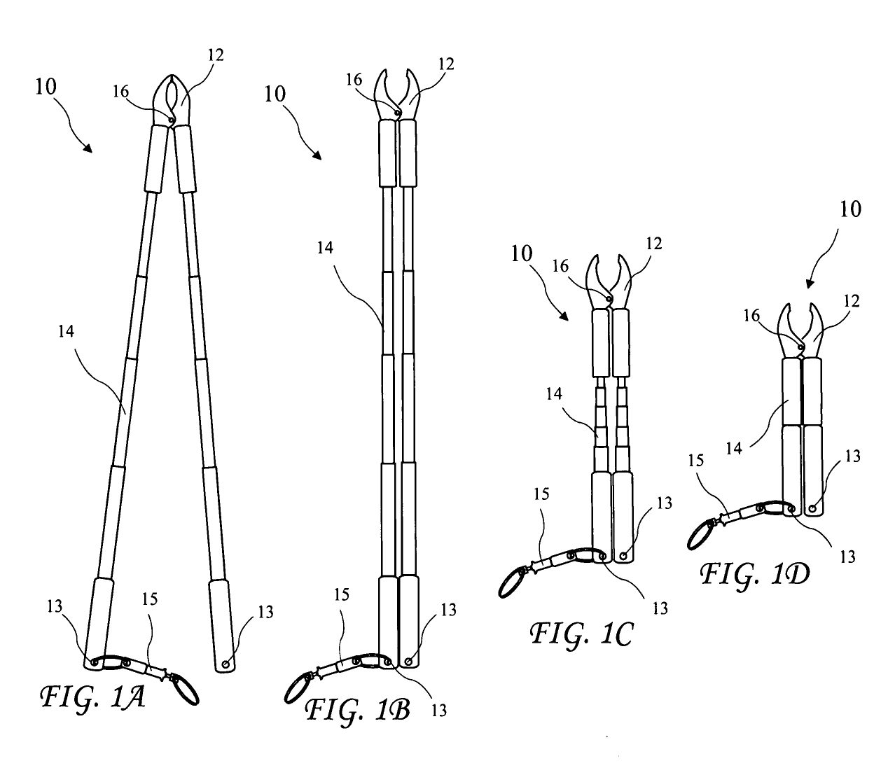

A side view of a reaching device 10 according to the present invention with telescoping handle 14 fully extended and jaws 12 in a closed position is shown in FIG. 1A, a side view of the reaching device 10 with the telescoping handles 14 fully extended and with the jaws 12 in an open position is shown in FIG. 1B, a side view of the reaching device 10 with the telescoping handles 14 partially extended and with the jaws 12 in an open position is shown in FIG. 1C, and a side view of the reaching device 10 with the telescoping handles 14 retracted and with the jaws 12 in an open position is shown in FIG. 1D. The jaws 12 pivot about a pivot pin 16 to open and close the jaws 12. The reaching device 10 includes a spring 26 (see FIGS. 3C and 4) which biases the jaws toward the closed position, and preferably biased the jaw 12 to a closed position. The handles 14 include telescoping sections which allow the handles 14 to be closed to a compact size for easy storing and carrying. A plunger type keychain 15 may be attached to the reaching device 10 at attachment points 13 on the ends of either handle 14.

The reaching device 10 may be a compact easily carried device, or a larger device for use in, for example, a shop or garage. With the telescoping handles 14 in the retracted position (see FIG. 1D) a compact embodiment of the reaching device is preferably sufficiently small to carry in an automobile glove compartment, a clothing pocket, to similar small area. Preferably, the overall length of the compact embodiment of the reaching device 10, with the handles 14 retracted, is less than approximately seven inches, and more preferably between approximately six and approximately seven inches.

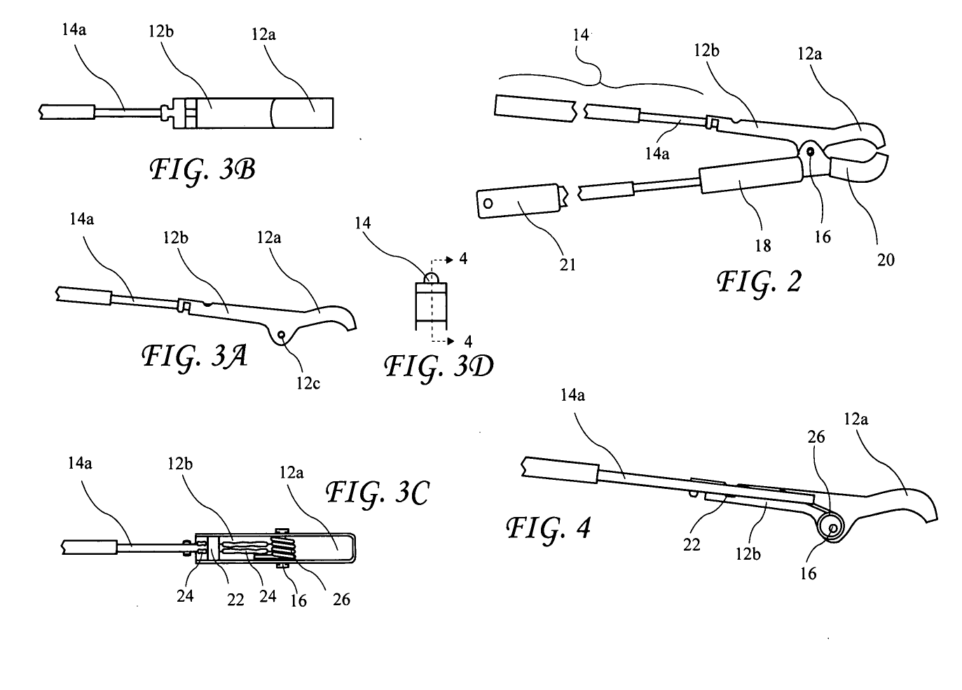

A detailed partial side view of the reaching device 10 with a leg cover 18 residing on one leg, a jaw cover 20 residing on one jaw, and a handle cover 21 residing on an end of the handle 14 opposite the jaws 12, is shown in FIG. 2. Preferably, the reaching device 10 includes jaw covers 20 on both jaws 12a, leg covers 18 on both legs 12b, and handle covers 21 on both handles 14. Preferably, when the telescoping handles 14 are fully retracted (see FIG. 1D), the handle cover 21 meets or nearly meets the leg cover 18. An end section 14a of the telescoping handle 14 is attached to each leg 12b. The end section may be a large diameter end of the telescoping handle 14, but is preferably a small diameter end (i.e., the inner telescoping section) of the telescoping handle 14.

A side view of one end section 14a of the telescoping handle 14, one leg 12b, and one jaw 12a of the reaching device 10 is shown in FIG. 3A, a top view of the end section 14a of the telescoping handle 14, the leg 12b, and the jaw 12a of the reaching device 10 is shown in FIG. 3B, a bottom view of the end section 14a of the telescoping handle 14, the leg 12b, and the jaw 12a of the reaching device 10 is shown in FIG. 3C, and a front view of the end section 14a of the telescoping handle 14, the leg 12b, and the jaw 12a of the reaching device 10 is shown in FIG. 3D. The leg 12b includes a receiving loop 22 and the ends section 14a passes through the loop 22 and into the leg 12b. Preferably, the end section 14a extends proximal to the pivot pin 16. The end section 14a is preferably brazed to the leg 12b by brazing 24, and more preferably by brazing 24 extending along most of the length of the end section 14a residing in the leg 12b. A spring 26 resides over the pivot pin 16 and biased the jaws 12a toward a closed position, and preferably biases the jaws to a closed position.

The telescoping handle 14 is generally constructed from thin wall tubing. The torque applied to the end section 14a near the entry of the end section 14a into the leg 12b may be large, and approaches the limit of the end section 14a. Thin wall tubing loses much of its strength if it is deformed, for example, flattened. As a result, it is important to retain the original shape of the end section 14a, and to not crimp and deform the end section 14a when constructing the reaching device 10.

A cross-sectional view of the reaching device 10 taken along line 44 of FIG. 3D is shown in FIG. 4. The end section 14a is seen to enter the leg 12b, pass through the loop 22, and extend proximal to the pivot pin 16.

The reaching tool may be used by holding the handles 14 in one hand, positioning the jaws 12 on opposite sides of an object to be retrieved, preferably aligned at a narrow portion of the object, and releasing one of the handles to allow the jaws to snap closed on the object. The reaching tool thus allows reaching for an object using a single hand.

While the invention herein disclosed has been described by means of specific embodiments and applications thereof, numerous modifications and variations could be made thereto by those skilled in the art without departing from the scope of the invention set forth in the claims.

I claim:

1. A reaching device comprising:
a first member having a first jaw, a first leg opposite the first jaw, and a first pivot between the first jaw and the first leg;
a second member having a second jaw opposing the first jaw, a second leg opposite the second jaw and opposing the first leg, and a second pivot between the second jaw and the second leg and coaxial with the first pivot;
a pivot pin passing through the first pivot and the second pivot to pivotally join the first member and the second member;
a spring cooperating with the first member and the second member to bias the first jaw and the second jaw towards a close position;
a first telescoping arm connected to the first leg and extendable approximately opposite the first jaw; and
a second telescoping arm connected to the second leg and extendable approximately opposite the second jaw.

2. The reaching device of claim 1, wherein the spring is a coil spring and resides over the pivot pin.

3. The reaching device of claim 2, wherein the spring includes spring ends residing against inside faces of the legs to bias the jaws towards a closed position.

4. The reaching device of claim 1, wherein the legs include receiving loops and the telescoping arms pass through the receiving loops.

5. The reaching device of claim 4, wherein the telescoping arms are brazed to the legs.

6. The reaching device of claim 5, wherein:
the telescoping arms include a multiplicity of telescoping sections transitioning from a smaller inner section to a larger outer section; and
the inner section of each leg is brazed to one of the legs.

7. The reaching device of claim 5, wherein the inner sections of the telescoping arms are brazed to the legs.

8. The reaching device of claim 7, wherein the inner sections pass through the receiving loops and into the legs extending into the legs to a point proximal to the pivots.

9. The reaching device of claim 1, wherein:
the telescoping arms include a multiplicity of telescoping sections transitioning from a smaller inner section to a larger outer section;
at least one end section of each leg is attached to each of the legs; and
the attached sections retain their original shapes.

10. The reaching device of claim 1, wherein with the handles in a retracted position, the reaching device has an overall length less than approximately seven inches, thereby allowing carrying in an automobile glove compartment of in clothing pockets.

11. The reaching device of claim 10, wherein with the handles in a retracted position, the reaching device has an overall length between approximately six inches and approximately seven inches, thereby allowing carrying in an automobile glove compartment of in clothing pockets.

12. A compact reaching device comprising:
an alligator clip comprising:
a first member having a first jaw, a first leg opposite the first jaw, and a first pivot between the first jaw and the first leg, the first leg having a first receiving loop;
a second member having a second jaw opposing the first jaw, a second leg opposite the second jaw and opposing the first leg, and a second pivot between the second jaw and the second leg and coaxial with the first pivot, the second leg having a second receiving loop;
a pivot pin passing through the first pivot and the second pivot to pivotally join the first member and the second member; and
a spring cooperating with the first member and the second member to bias the first jaw and the second jaw towards a close position;
a first arm having telescoping sections, a smallest telescoping section of the telescoping sections passing through the first receiving loop, reaching proximal to the pivot pin, and connected to the first leg of the alligator clip, the first arm extendable approximately opposite the first jaw; and
a second arm having telescoping sections, a smallest telescoping section of the telescoping sections passing through the second receiving loop, reaching proximal to the pivot pin, and connected to the second leg of the alligator clip, the second arm extendable approximately opposite the second jaw,
wherein the overall length of the reaching device with the handles in a retracted position is less than approximately seven inches.

13. A reaching device comprising:
an alligator clip comprising:
a first member having a first jaw, a first leg opposite the first jaw, and a first pivot between the first jaw and the first leg, the first leg having a first receiving loop;
a second member having a second jaw opposing the first jaw, a second leg opposite the second jaw and opposing the first leg, and a second pivot between the second jaw and the second leg and coaxial with the first pivot, the second leg having a second receiving loop;
a pivot pin passing through the first pivot and the second pivot to pivotally join the first member and the second member; and
a spring cooperating with the first member and the second member to bias the first jaw and the second jaw towards a close position;
a first arm having telescoping sections, a smallest telescoping section of the telescoping sections reaching proximal to the pivot pin, and brazed to the first leg of the alligator clip, the first arm extendable approximately opposite the first jaw; and
a second arm having telescoping sections, a smallest telescoping section of the telescoping sections, reaching proximal to the pivot pin, and brazed to the second leg of the alligator clip, the second arm extendable approximately opposite the second jaw.
